(19) United States
(12) Patent Application Publication
(10) Pub. No.: US 2019/0180280 A1
(43) Pub. Date: Jun. 13, 2019

(54) SYSTEM AND COMPUTER-IMPLEMENTED METHOD FOR AUTHENTICATING COMMUNICATIONS AND COMMUNICATIVE DEVICES IN REAL TIME

(71) Applicant: Mastercard International Incorporated, Purchase, NY (US)

(72) Inventors: Richard B. Unnerstall, O'Fallon, MO (US); Sai Sudha Venkata Chaganti, Ballwin, MO (US); Mahesh Nagure, O'Fallon, MO (US); Lova Padmini Devi Yasarapu, Town and Country, MO (US); Nikhil Muppidi, O'Fallon, MO (US); Mohandas Vonga, O'Fallon, MO (US)

(73) Assignee: Mastercard International Incorporated, Purchase, NY (US)

(21) Appl. No.: 15/835,275

(22) Filed: Dec. 7, 2017

(51) Int. Cl. G06Q 20/40; G06Q 20/34; G06Q 20/32

(52) U.S. Cl. CPC G06Q 20/4014; G06Q 20/3223; G06Q 20/351

(57) ABSTRACT

A system and computer-implemented method for protecting against fraud by authenticating communications and communicative devices in real time and prior to accepting instructions or otherwise substantively engaging via the devices. A software app on the mobile phone of a cardholder creates a token, which is also provided to a card issuer. Historical authentication information is collected about the mobile phone and an associated cardholder. An authentication request, including the token, is received from the card issuer when communication is initiated by the mobile device. Current authentication information is also collected. The historical and current authentication information is analyzed, an authentication result is generated reflecting a likelihood that the mobile phone is being legitimately used by the cardholder associated with it, and the authentication result is communicated to the card issuer. Based on the authentication result, the card issuer decides whether to continue engaging in the communication via the mobile phone.

### FIELD

The present invention relates to systems and methods for analyzing communications and protecting against fraud, and more particularly, embodiments provide a system and computer-implemented method for protecting against fraud by authenticating mobile and other communications devices and/or communicative devices in real time and prior to accepting instructions or otherwise substantively engaging via the devices.

### BACKGROUND

Service providers often communicate with customers via mobile phones and other communications devices. For example, an interchange network, such as Mastercard, Inc., may have many hundreds of card-issuing partners who service billions of cardholders conducting tens of billions of transactions annually. The card issuers maintain call centers for communicating with the cardholders via the cardholders' communications devices, and the cardholders expect excellent experiences during these communications. However, by one estimate, approximately one of every two thousand calls is fraudulent, and fraud has increased forty-five percent and fraud loss has increased fourteen percent in the last two years. Further, there has been a substantial increase in the incidence of mobile phone identity theft. As a result, call centers can be weak points in overall security leading to account takeovers, fraudulent card activations, voice phishing, card-not-present transactions, and cross-channel attacks. Efforts to ameliorate these undesirable risks and results have been limited to analyzing incoming call data.

This background discussion is intended to provide information related to the present invention which is not necessarily prior art.

### SUMMARY

Embodiments address the above-described and other problems by providing a system and computer-implemented method for protecting against fraud by authenticating mobile and other communications and/or communicative devices in real time and prior to accepting instructions or otherwise substantively engaging via the devices.

In a first embodiment of the present invention, a computer-implemented method is provided for improving the functioning of a computer for authenticating an electronic communications device, and may broadly comprise the following. A software application may be stored on the communications device. An identifying data element may be created and stored on the communications device, and the identifying data element may be provided to a service provider. Historical authentication information may be collected and stored about the communications device. An authentication request may be received from the service provider, wherein the authentication request may include the identifying data element from the communications device attempting to engage in electronic communications with the service provider. Current authentication information may be collected and stored about the communications device. The historical and current authentication information may be analyzed, an authentication result may be generated reflecting a likelihood that the communications device is being legitimately used by an accountholder, and the authentication result may be electronically communicated to the service provider. The service provider may continue to engage in the communication via communications device based at least in part on the authentication result.

In a second embodiment, a computer-implemented method is provided for improving the functioning of a computer for authenticating an electronic communicative device, and may broadly comprise the following. A software application may be stored on the communicative device. An identifying data element may be created and stored on the communicative device, and the identifying data element may be provided to a service provider. Historical authentication information may be collected and stored about the communicative device. An authentication request may be received from the service provider, wherein the authentication request includes the identifying data element from the communicative device attempting to engage in electronic communications with the service provider. Current authentication information may be collected and stored about the communicative device. The historical and current authentication information may be analyzed, an authentication result may be generated reflecting a likelihood that the communicative device is being legitimately used by an accountholder, and the authentication result may be communicated to the service provider. The service provider may continue to engage in the communication via the communicative device based at least in part on the authentication result.

Various implementations of the foregoing embodiments may include any one or more of the following additional features. The communications device may be a mobile phone, the accountholder may be a cardholder of a payment card, and the service provider may be a card issuer of the payment card. The communicative device may be physically associated with a member of the group consisting of: vehicles, appliances, machinery, and buildings. The identifying data element may include an identifying characteristic of the device, account information associated with the device, and/or an identifying characteristic of the accountholder. The historical and current authentication information may include a device connection pattern based on a plurality of communication connections by the device, a movement pattern based on a plurality of geographic locations of the device, and/or data from a second software application. The method may further include collecting and storing historical authentication information and current authentication information about the accountholder. The method may further include the service provider conducting a preliminary authentication check, wherein the service provider continues to engage in the communication via the device based at least in part on the preliminary authentication check and the authentication result. The authentication result may include an authentication score calculated based on the historical and current authentication information, and the authentication result may include a summary of at least part of the historical and current authentication information.

This summary is not intended to identify essential features of the present invention, and is not intended to be used to limit the scope of the claims. These and other aspects of the present invention are described below in greater detail.

### DRAWINGS

Embodiments of the present invention are described in detail below with reference to the attached drawing figures, wherein:

FIG. 1 is a depiction of an embodiment of a system for authenticating mobile and other communications and/or communicative devices; and

FIG. 2 is a flowchart of steps in an embodiment of a computer-implemented method for authenticating mobile and other communications and/or communicative devices.

The figures are not intended to limit the present invention to the specific embodiments they depict. The drawings are not necessarily to scale.

### DETAILED DESCRIPTION

The following detailed description of embodiments of the invention references the accompanying figures. The embodiments are intended to describe aspects of the invention in sufficient detail to enable those with ordinary skill in the art to practice the invention. The embodiments of the invention are illustrated by way of example and not by way of limitation. Other embodiments may be utilized and changes may be made without departing from the scope of the claims. The following description is, therefore, not limiting. It is contemplated that the invention has general application to processing financial transaction data by a third party in industrial, commercial, and residential applications. The scope of the present invention is defined only by the appended claims, along with the full scope of equivalents to which such claims are entitled.

In this description, references to “one embodiment,” “an embodiment,” or “embodiments” mean that the feature or features referred to are included in at least one embodiment of the invention. Separate references to “one embodiment,” “an embodiment,” or “embodiments” in this description do not necessarily refer to the same embodiment and are not mutually exclusive unless so stated. Specifically, a feature, component, action, step, etc. described in one embodiment may also be included in other embodiments, but is not necessarily included. Thus, particular implementations of the present invention can include a variety of combinations and/or integrations of the embodiments described herein.

Broadly characterized, the present invention relates to systems and methods for analyzing communications and protecting against fraud. More particularly, embodiments provide a system and computer-implemented method for protecting against fraud by authenticating mobile and other communications and/or communicative devices prior to accepting instructions or otherwise substantively engaging via the devices. One embodiment may provide a method of authenticating mobile phones in real time for contact centers affiliated with or part of the systems of payment card issuers, thereby reducing or eliminating the opportunity for criminals to manipulate contact center agents, make fraudulent purchases, and/or execute identity theft schemes by stealing or impersonating cardholders' mobile phones.

Broadly, a user of a communications device (e.g., a cardholder of a payment card or other accountholder using a mobile phone), having installed a software application (“app”) that creates an identifying data element (“token”), may initiate communication with a service provider (e.g., a contact center aspect of a card issuer of the payment card or other financial institution). One implementation of the token may include certain identifying characteristics of the communications device. Additionally or alternatively, the token may further include characteristics of the app itself, a credential of the service provider, biometric data of the accountholder, and/or geolocation data of the communications device and/or accountholder.

The service provider may receive the token, perform a preliminary authentication check on the user and the communications device, and transmit a request to an information provider (e.g., an interchange network, such as Mastercard) for a more thorough authentication check. The information provider may collect and analyze historical and current data relevant to authenticating the communications device, and transmit a response to the service provider. The response may include an authentication result and/or score which quantifies or otherwise expresses the likelihood that the communications device is being legitimately used by an accountholder. The service provider may then decide whether to accept instructions or otherwise substantively engage via the communications device.

Another embodiment may provide a method of authenticating communicative devices associated with larger devices, such as vehicles, appliances, machinery, and/or buildings, in real time for contact centers affiliated with or part of the systems of providers of goods (e.g., food, fuel, or other consumables) and/or services (e.g., maintenance), thereby reducing or eliminating the opportunity for criminals to manipulate contact center agents, make fraudulent purchases, and/or execute identity theft schemes by stealing or impersonating accountholder's devices.

Thus, although generally described herein for illustrative purposes in the context of a cardholder or other accountholder using a mobile phone to call a call center of a card issuer, embodiments may be adapted for substantially any form of financial account at any financial institution, any communications device (e.g., laptop or tablet computers), any communicative device (e.g., vehicles or other equipment or structures having a communications element), and any service provider having a desire or need for authenticating customer communications. Embodiments deliver a number of advantages, including providing a low cost lightweight solution for fast, substantially automatic, multi-factor call authentication that is substantially transparent to callers and that reduces or eliminates the opportunity for fraudulent calls.

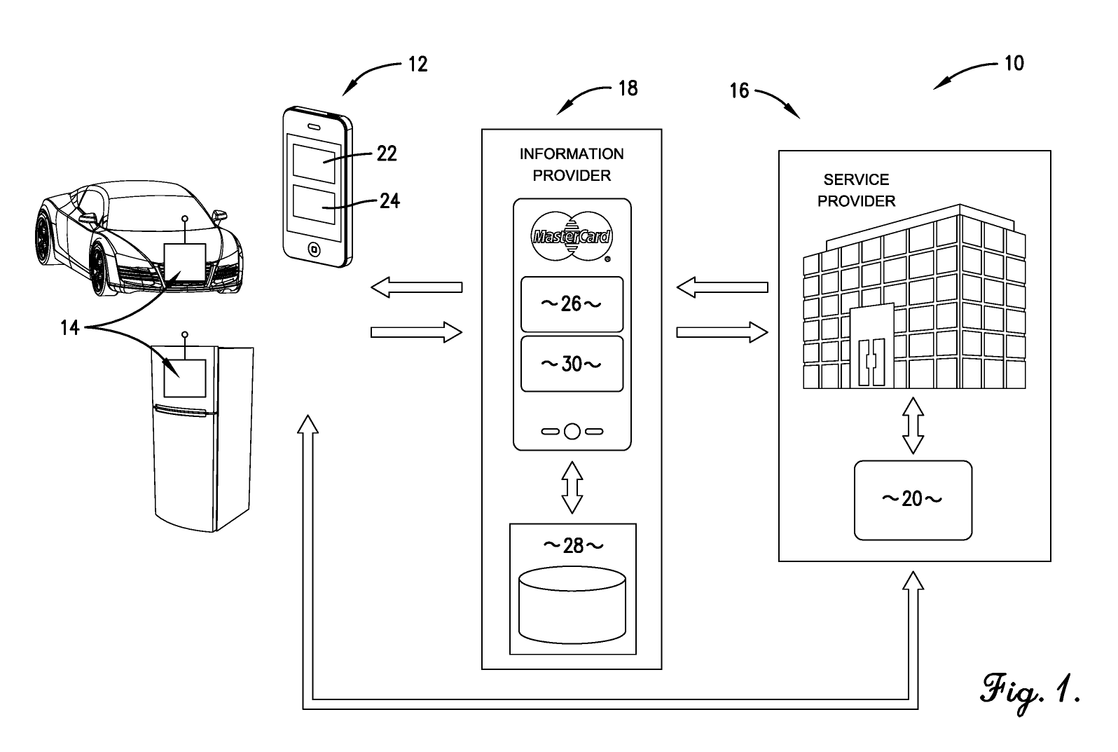

Referring to FIG. 1, an embodiment of a system 10 is shown for protecting against fraud by authenticating mobile and other communications devices and/or communicative devices prior to accepting instructions or otherwise substantively engaging via the devices. The system 10 may broadly include the communications device 12 and/or communicative device 14; a service provider system 16; and an information provider 18. The communications device 12 may be configured to exchange electronic communications with the service provider system 16 regarding a payment card or other financial account, and may include substantially any suitable communications technology, such as mobile phone, or laptop or tablet computer technology. The communicative device 14 may be configured to exchange electronic communications with the service provider system 16 regarding the provision of goods and/or services. The communicative device 14 may be used by its owner or may automatically engage in communication on behalf of its owner. The communicative devices 14 may be associated with, e.g., vehicles, appliances, machinery, and/or buildings, and may be part of the Internet of Things (IoT). In one implementation, the communicative device 14 may include a communications element and computer programming controlling use of the communications element to contact the service provider system 16 regarding the ordering of goods (e.g., food, fuel, or other consumables) and/or services (e.g., maintenance). The remainder of the description will focus on an illustrative implementation involving the communications device 12, but an implementation involving the communicative device 14 may proceed substantially identically (in general, only the subject of the communications and the nature of the service provider may change), except as may be noted.

The service provider system 16 may be configured to exchange electronic communications with the communications device 12 regarding the payment card or other financial account, and with the information provider 18 to request an authentication check of the accountholder and the communications device 12. The service provider system 16 may be further configured to perform its own a first or preliminary authentication check. The service provider system 16 may include substantially any suitable communication technology such as a manned, semi-automated, or automated call or other contact center 20.

The information provider system 18 may be configured to provide a software app 22 to the communications device 12 for generating an identifying token 24, to collect and analyze historical and current data relevant to authenticating the communications device 12, and transmit a response to the authentication request quantifying the likelihood that the communications device 12 belongs to an accountholder and is being legitimately used by (or on behalf of) that accountholder. The information provider system 18 may include substantially any suitable data collection and analysis technology. In one implementation, the information provider system 18 may be a substantially automated headless system (i.e., a system without a monitor, graphical user interface (GUI) or peripheral devices, such as keyboard and mouse), and include an electronic communications element 26, and electronic memory element 28; and an electronic processing element 30.

The electronic communications element 26 may be configured to exchange electronic communications, including transmitting the software app 22 to the communications device 12, and transmitting an authentication result to the service provider system 16. The electronic memory element may 28 be configured to store historical and current data relevant to authenticating at least the communications device 12. The electronic processing element 30 may be configured to analyze the historical and current data, and to generate and transmit via the communications element 26 an authentication result to the service provider 16 quantifying the likelihood that the communications device 12 belongs to an accountholder and is being legitimately used by (or on behalf of) that accountholder.

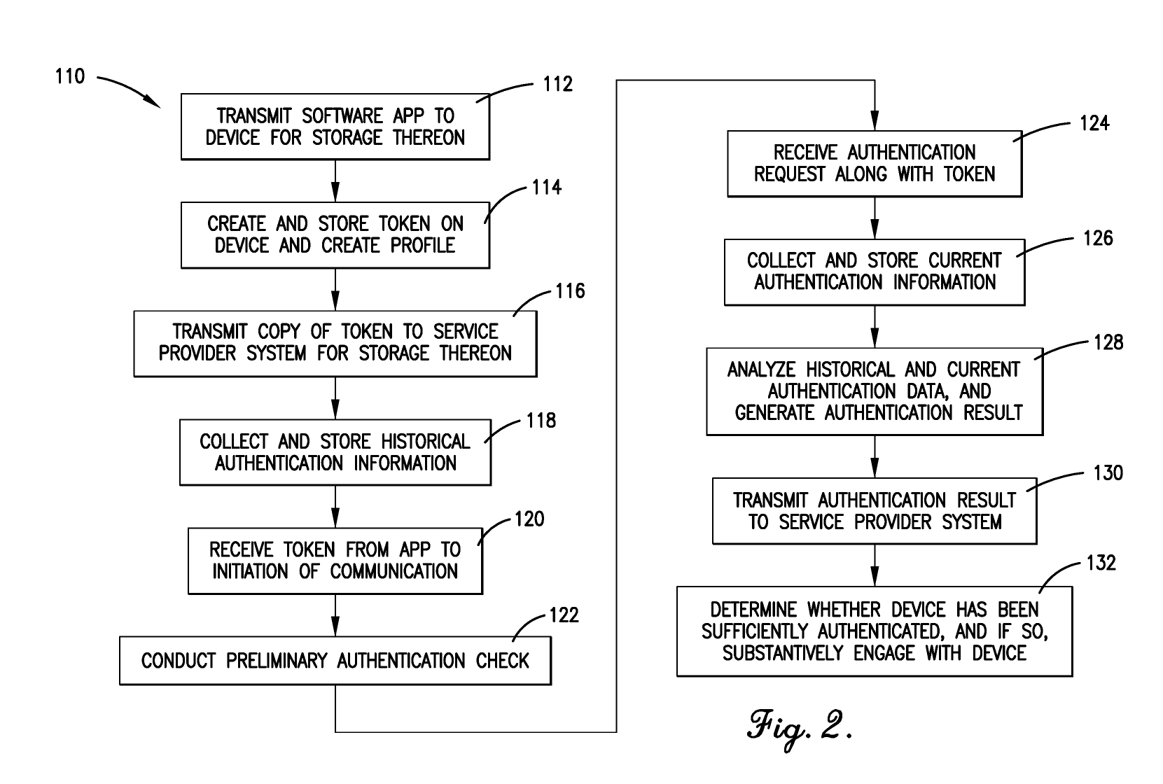

Referring also to FIG. 2, the system 10 may function substantially as follows. The app 22 may be transmitted to and stored on the communications device 12, as shown in 112. The token 24 may be created and stored on the communications device 12, as shown in 114, and provided to the service provider system 16, as shown in 116. Historical authentication information may be collected about the communications device 12 and stored in the memory element 28, as shown in 118. An authentication request may be received from the service provider 16, as shown in 124, wherein the authentication request may include the token 24 from the communications device 12 attempting to engage in electronic communications with the service provider 16. Current authentication information may be collected about the communications device 12 and stored in the memory element 28, as shown in 126. The historical and current authentication information may be analyzed by the processing element 30, an authentication result may be generated by the processing element 30, as shown in 128, reflecting a likelihood that the communications device 12 is being legitimately used by an accountholder, and the authentication result may be electronically communicated to the service provider system 16, as shown in 130. The service provider system 16 may decide whether to continue to engage in the communication via the communications device 12 based at least in part on the authentication result, as shown in 132.

The system 10 may include more, fewer, or alternative components and/or perform more, fewer, or alternative actions, including those discussed elsewhere herein, and particularly those discussed in the following section describing the computer-implemented method.

Referring again to FIG. 2, an embodiment of a computer-implemented method 110 is shown for improving the functioning of a computer for protecting against fraud by authenticating mobile and other communications devices and/or communicative devices prior to accepting instructions or otherwise substantively engaging via the devices. The computer-implemented method 110 may be a corollary to the functionality of the system 10 of FIG. 1, and may be similarly implemented using the various components of the system 10 as described above. Broadly, the method 110 may proceed as follows.

Preliminarily, in response to a request from an accountholder using a mobile phone or other communications device 12 (or, as discussed, from a communicative device 14), the communications element 26 of the information provider system 18 may transmit a software app 22 to the device 12 for storage thereon, as shown in 112. Depending on the nature of the device 12, this process may involve the accountholder downloading and installing the app 22 in a substantially conventional manner.

The downloaded and installed app 22 may allow the accountholder to register the device 12 with the information provider system 18, and upon such registration, the communications element 26 of the information provider system 18 may assign and communicate to the device 12 a token 24, and the processing element 30 may create and store in the memory element 28 a profile containing relevant information about the accountholder and the communications device 12, as shown in 114. Registering the device 12 may involve accepting applicable terms and conditions, providing the name of the user's town, city or county of residence and/or zip code, and selecting one or more payment card or other accounts to protect from fraud using the authentication service of the present invention. The information provider system 18 may send a copy of the token 24 to the service provider system 16, as shown in 116.

An implementation of the token 24 may include identifying characteristics, or “DNA,” of the device 12, account information associated with device 12, and identifying characteristics of the accountholder who owns or at least uses the device 12. The token 24 may further include characteristics of the app 22, a credential of the card issuer or other service provider, biometric data of the accountholder, and/or geolocation data of the device 12. The identifying characteristics may include any or all of four fields, International Mobile Subscriber Identity (IMSI), Integrated Circuit Card ID (ICCID), International Mobile Equipment Identity (IMEI), Mobile Station ISDN number (MSISDN), and these may be fed into a one-way hash so that the individual unique device identifiers are obfuscated and indeterminate. The IMEI number may be checked against databases of stolen devices. If the device 12 is stolen, then the authentication result may be negative (e.g., the authentication score may be zero).

The profile may include the token 24, and may further include other relevant behaviors and behavior patterns, such as Internet Protocol (IP) device connection patterns, location alerts, and/or mobile app data. The IP device connection patterns may include the IP movements of the communications device 12 during the course of the day. For example, each time the accountholder switches from home, work, or 4G, a unique IP is detected and a pattern emerges which can be used to determine where the accountholder is most likely to be or, at least, what IP connection they are most likely to be using at the time of the communication with the service provider system 16. If the IP connection matches what is expected then the authentication result/score may be better/higher, and if it does not match what is expected then the authenticity result/score may be worse/lower. The IP device connection patterns may include home Wi-Fi (broadband providers), phone carrier IP Address attributes (AT&T, Sprint), work Wi-Fi IP address attributes, and BSSID (the MAC address of the Wi-Fi Chipset running on wireless access points).

The location alerts may include location strategy, location rules, accountholder home fence, distance triggers, Ztoken, device events, and/or location on demand. Accountholder home fence may be implemented as a pre-established distance from the accountholder's primary residence at which the app 22 transmits a location report to the information provider system 18. Similarly, distance triggers may be implemented as a series of pre-established distances from the accountholder's primary residence at which the app transmits location reports to the information service provider system 18. Thus, for example, if the fence is set at twenty miles, and the distance triggers are set at every fifty miles from the fence, then rather than first hearing from the app 22 when the accountholder attempts communication one thousand miles from their home, the information service provider system 18 will have a complete record of the accountholder's movements between their home and the point of contact one thousand miles away, which helps to authenticate the communication device 12 making the communication. Device events may include such events as the communication device 12 entering airplane mode, which would indicate that communication device 12 is on an airplane.

The data provided by the app 22 to the information service provider system 18 may include data from other software apps such as Digital Wallet, Fitbit, and Merchant Purchase information. Fitbit data may indicate whether the accountholder is asleep, and therefore would not likely be initiating the current communication. The digital wallet data may indicate whether the user is making other transactions. Additionally or alternatively, if the app 22 determines that the communications device 12 has been stolen, then the app 22 may be selectively configurable to disable its owner's digital wallet to deny the thief access to it.

The information provider system 18 may collect and store in the memory element 28 historical authentication information about the accountholder and the communications device 12, which is relevant to authenticating the communications device 12, as shown in 118. The historical authentication information may include at least some or all of the data and behavioral patterns described above with regard to the profile.

The accountholder may initiate a call or other communication with the contact center 20 of the service provider system 16, which may result in the service provider system 16 receiving the token 24 from the app 22, as shown in 120. The service provider system 16 may conduct a first or preliminary authentication check, as shown in 122. The preliminary authentication check may involve checking such information as the caller's name and account number, and answers to one or more security questions, etc. In an alternative implementation, the preliminary authentication check may not be performed.

Following or simultaneous with the preliminary authentication check, the information provider system 18 may receive via the communications element 26 an authentication request, including the token 24, from the service provider system 16 to perform a more detailed authentication check, as shown in 124. In conducting the authentication check, the information provider system 18 may collect and store in the memory element 28 current authentication information, as shown in 126. The current authentication check may include more current information for at least some or all of the data and behavioral patterns described above with regard to the profile. The processing element 30 of the information provider system 18 may analyze the historical and current authentication information, and based thereon, generate an authentication result, as shown in 128. The authentication result may take the form of an authentication score, some or all of the data used in generating the authentication result/score, some or all of any additional data checked, or any combination thereof. The information provider system 18 may transmit via the communication element 26 the authentication result to the service provider system 16, as shown in 130.

Based on the preliminary authentication check by the service provider system 16, if one was conducted, and on the authentication result of the second authentication check by the information provider system 18, the service provider system 16 may determine whether the communications device 12 has been sufficiently authenticated such that the service provider system 16 will accept instructions or otherwise substantively engage via the communications device 12, as shown in 132.

Additionally or alternatively, the method 110 may be adapted to allow the service provider's system 16 to initiate the electronic communication with the accountholder via the communications device 12 while still authenticating the device 12 in substantially the same manner before accepting instructions or otherwise substantively engaging the device 12.

The computer-implemented method 110 may include more, fewer, or alternative actions, including those discussed elsewhere herein.

Any actions, functions, steps, and the like recited herein may be performed in the order shown in the figures and/or described above, or may be performed in a different order. Furthermore, some steps may be performed concurrently as opposed to sequentially. Although the computer-implemented method is described above, for the purpose of illustration, as being executed by an exemplary system and/or exemplary physical elements, it will be understood that the performance of any one or more of such actions may be differently distributed without departing from the spirit of the present invention.

A computer-readable medium comprising a non-transitory medium may include an executable computer program stored thereon and for instructing one or more processing elements to perform some or all of the steps described herein, including some or all of the steps of the computer-implemented method. The computer program stored on the computer-readable medium may instruct the processing element and/or other components of the system to perform additional, fewer, or alternative actions, including those discussed elsewhere herein.

All terms used herein are to be broadly interpreted unless otherwise stated. For example, the term “payment card” and the like may, unless otherwise stated, broadly refer to substantially any suitable transaction card, such as a credit card, a debit card, a prepaid card, a charge card, a membership card, a promotional card, a frequent flyer card, an identification card, a prepaid card, a gift card, and/or any other device that may hold payment account information, such as mobile phones, Smartphones, personal digital assistants (PDAs), key fobs, and/or computers. Each type of transaction card can be used as a method of payment for performing a transaction.

The terms “processing element,” “processor,” and the like, as used herein, may, unless otherwise stated, broadly refer to any programmable system including systems using central processing units, microprocessors, microcontrollers, reduced instruction set circuits (RISC), application specific integrated circuits (ASIC), logic circuits, and any other circuit or processor capable of executing the functions described herein. The above examples are example only, and are thus not intended to limit in any way the definition and/or meaning of the term “processing element.” In particular, “a processing element” may include one or more processing elements individually or collectively performing the described functions. In addition, the terms “software,” “computer program,” and the like, may, unless otherwise stated, broadly refer to any executable code stored in memory for execution on mobile devices, clusters, personal computers, workstations, clients, servers, and a processor or wherein the memory includes read-only memory (ROM), electronic programmable read-only memory (EPROM), random access memory (RAM), erasable electronic programmable read-only memory (EEPROM), and non-volatile RAM (NVRAM) memory. The above memory types are exemplary only, and are thus not limiting as to the types of memory usable for storage of a computer program.

The terms “computer,” “computing device,” and the like, as used herein, may, unless otherwise stated, broadly refer to substantially any suitable technology for processing information, including executing software, and may not be limited to integrated circuits referred to in the art as a computer, but may broadly refer to a microcontroller, a microcomputer, a programmable logic controller (PLC), an application specific integrated circuit, and other programmable circuits, and these terms are used interchangeably herein.

The term “communications network” and the like, as used herein, may, unless otherwise stated, broadly refer to substantially any suitable technology for facilitating communications (e.g., GSM, CDMA, TDMA, WCDMA, LTE, EDGE, OFDM, GPRS, EV-DO, UWB, WiFi, IEEE 802 including Ethernet, WiMAX, and/or others), including supporting various local area networks (LANs), personal area networks (PAN), or short range communications protocols.

The term “communications element” and the like, as used herein, may, unless otherwise stated, broadly refer to substantially any suitable technology for facilitating communications, and may include one or more transceivers (e.g., WWAN, WLAN, and/or WPAN transceivers) functioning in accordance with IEEE standards, 3GPP standards, or other standards, and configured to receive and transmit signals via a communications network.

The term “memory element,” “data storage device,” and the like, as used herein, may, unless otherwise stated, broadly refer to substantially any suitable technology for storing information, and may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others.

Although the invention has been described with reference to the one or more embodiments illustrated in the figures, it is understood that equivalents may be employed and substitutions made herein without departing from the scope of the invention as recited in the claims.

Having thus described one or more embodiments of the invention, what is claimed as new and desired to be protected by Letters Patent includes the following:

1. A computer-implemented method for improving the functioning of a computer for authenticating an electronic communications device, the computer-implemented method comprising:
storing a software application on the electronic communications device;
creating and storing an identifying data element on the electronic communications device;
providing the identifying data element to a service provider;
collecting and storing historical authentication information about the electronic communications device;
receiving an authentication request from the service provider, wherein the authentication request includes the identifying data element from the electronic communications device attempting to engage in electronic communication with the service provider;
collecting and storing current authentication information about the electronic communications device;
analyzing the historical and current authentication information and generating an authentication result reflecting a likelihood that the electronic communications device is being legitimately used by an accountholder;
communicating the authentication result to the service provider; and
continuing to engage in the electronic communication via the electronic communications device based at least in part on the authentication result.

2. The computer-implemented method of claim 1, wherein the electronic communications device is a mobile phone, the accountholder is a cardholder of a payment card, and the service provider is a card issuer of the payment card.

3. The computer-implemented method of claim 1, wherein the identifying data element includes—
an identifying characteristic of the electronic communications device;
account information associated with the electronic communications device; and
an identifying characteristic of the accountholder.

4. The computer-implemented method of claim 1, wherein the historical and current authentication information includes—
a device connection pattern based on a plurality of communications connections by the electronic communications device;
a movement pattern based on a plurality of geographic locations of the electronic communications device; and
data from a second software application.

5. The computer-implemented method of claim 1, further including collecting, storing, and analyzing historical and current authentication information about the accountholder.

6. The computer-implemented method of claim 1, further including the service provider conducting a preliminary authentication check, wherein the service provider continues to engage in the electronic communications via the communications device based at least in part on the preliminary authentication check and the authentication result.

7. The computer-implemented method of claim 1, wherein the authentication result includes an authentication score calculated based on the historical and current authentication information.

8. The computer-implemented method of claim 1, wherein the authentication result includes a summary of at least part of the historical and current authentication information.

9. A computer-implemented method for improving the functioning of a computer for authenticating a mobile phone, the computer-implemented method comprising:
storing a software application on the mobile phone of a cardholder of a payment card;
creating and storing an identifying data element on the mobile phone;
providing the identifying data element to a card issuer of the payment card;
collecting and storing historical authentication information about the mobile phone and the cardholder associated with the mobile phone;
receiving the identifying data element at the card issuer from the software application when the mobile phone attempts to engage in electronic communication with the card issuer;
conducting a preliminary authentication check;
receiving an authentication request from the card issuer, wherein the authentication request includes the identifying data element;
collecting and storing current authentication information about the mobile phone and the cardholder;
analyzing the historical and current authentication information and generating an authentication result reflecting a likelihood that the mobile phone is being legitimately used by the cardholder associated with the mobile phone;
communicating the authentication result to the card issuer; and
continuing to engage in the electronic communication via the mobile phone based at least in part on the preliminary authentication check and the authentication result.

10. The computer-implemented method of claim 9, wherein the identifying data element includes—
an identifying characteristic of the mobile phone;
account information associated with the mobile phone; and
an identifying characteristic of the cardholder.

11. The computer-implemented method of claim 9, wherein the historical and current authentication information includes—
a device connection pattern based on a plurality of communication connections by the mobile phone;
a movement pattern based on a plurality of geographic locations of the mobile phone; and
data from a second software application.

12. The computer-implemented method of claim 9, wherein the authentication result includes an authentication score calculated based on the historical and current authentication information.

13. A computer-implemented method for improving the functioning of a computer for authenticating an electronic communicative device, the computer-implemented method comprising:
storing a software application on the electronic communicative device;
creating and storing an identifying data element on the electronic communicative device;
providing the identifying data element to a service provider;
collecting and storing historical authentication information about the electronic communicative device;
receiving an authentication request from the service provider, wherein the authentication request includes the identifying data element from the electronic communicative device attempting to engage in electronic communication with the service provider;
collecting and storing current authentication information about the electronic communicative device;
analyzing the historical and current authentication information and generating an authentication result reflecting a likelihood that the electronic communicative device is being legitimately used by an accountholder;
communicating the authentication result to the service provider; and
continuing to engage in the electronic communication via the electronic communicative device based at least in part on the authentication result.

14. The computer-implemented method of claim 13, wherein the electronic communicative device is physically associated with a member of the group consisting of:
vehicles, appliances, machinery, and buildings.

15. The computer-implemented method of claim 13, wherein the identifying data element includes—
an identifying characteristic of the electronic communicative device;
account information associated with the electronic communicative device; and
an identifying characteristic of the accountholder.

16. The computer-implemented method of claim 13, wherein the historical and current authentication information includes—
a device connection pattern based on a plurality of communication connections by the electronic communicative device,
a movement pattern based on a plurality of geographic locations of the electronic communicative device, and
data from a second software application.

17. The computer-implemented method of claim 13, further including collecting and storing historical authentication information and current authentication information about the accountholder.

18. The computer-implemented method of claim 13, further including the service provider conducting a preliminary authentication check, wherein the service provider continues to engage in the electronic communication via the electronic communicative device based at least in part on the preliminary authentication check and the authentication result.

19. The computer-implemented method of claim 13, wherein the authentication result includes an authentication score calculated based on the historical and current authentication information.

20. The computer-implemented method of claim 13, wherein the authentication result includes a summary of at least part of the historical and current authentication information.
